(19) United States
(12) Patent Application Publication
(10) Pub. No.: US 2010/0058399 A1
(43) Pub. Date: Mar. 4, 2010

(54) METHOD AND ANTENNA SYSTEM FOR SATELLITE LOCK-ON BY CHANNEL SELECTION

(75) Inventors: Wen-Chao Shen, Taoyuan (TW); Wen-Yen Shen, Taoyuan (TW); Shun-Ching Chen, Taipei City (TW)

Correspondence Address: ROSENBERG, KLEIN & LEE, 3458 ELLICOTT CENTER DRIVE-SUITE 101, ELLICOTT CITY, MD, 21043, US

(73) Assignee: AZURE SHINE INTERNATIONAL INC., TAOYUAN (TW)

(21) Appl. No.: 12/469,938

(22) Filed: May 21, 2009

(30) Foreign Application Priority Data
Aug. 26, 2008 (TW) 097132477

(51) Int. Cl. H04N 7/20; G01S 1/00

(52) U.S. Cl. 725/72; 342/357.09

(57) ABSTRACT

A method for satellite lock-on in an antenna system by channel selection is initiated by receiving a channel selection signal. The channel selection signal is flagged to retrieve satellite parameters corresponding to the selected channel from a pre-stored satellite channel table which provides a correlation among the channels, the bands and the satellite coordinates. Then, according to the retrieved satellite parameters, an antenna control signal and thus a drive signal are generated orderly to drive the antenna to direct at the satellite responsible to the selected channel.

This application claims the benefit of Taiwan Patent Application No. 097132477, filed Aug. 26, 2008, the subject matter of which is incorporated herein by reference.

### BACKGROUND OF THE INVENTION

(1) Field of the Invention

The invention relates to a satellite lock-on technology and, more particularly, to a technology that utilizes channel selection to lock onto a target satellite.

(2) Description of the Prior Art

Satellite technology has been developed and exploited to make our daily life more conveniently in various ways. For example, global positioning system (GPS) products, such as positioning apparatuses, mobile phones, broadcasting apparatuses and navigation devices, have brought people closer geographically and visualized the image of a global village. Moreover, the increasing progress in broadcasting via satellite has realized “real-time” TV programs in the broadcasting industry, which allows a variety of programs to play at any corner around the world.

In the prior art, the satellite broadcasting technology may be classified into a stationary broadcasting type and a mobile broadcasting type. Regarding the stationary broadcasting type, a satellite antenna system may be constructed on the ground or a suitable fixed construction. Such type of broadcasting may download satellite parameters, actuate the antenna system so as to aim at a target satellite, and establish a bi-directional signal and data link between the ground station and the satellite. However, the stationary broadcasting type of satellites may only support limited space coverage due to the nature of immobility. As a result, signal broadcast via DVB-T (Digital Video Broadcasting-Terrestrial) may not be reached when outside the field pattern.

To overcome the disadvantage of limited space coverage, the mobile broadcasting type provides a feasible way of solution. One of the main applications of the mobile broadcasting is the satellite news gathering (SNG) vehicle. An SNG vehicle is provided with an on-top antenna system for tracking satellites and processing bi-directional signal/data communications when the antenna system is locked onto a target satellite.

To change a tracking target from one to another, satellite parameters are renewed for the new satellite before sent to the database of the antenna system. In implementation, the database of the antenna system may store parameters of all prospective satellites in advance so as to facilitate satellite selection. Alternatively, the antenna system may obtain satellite parameters from an earth satellite transmission station or a satellite control center when a new tracking is started.

For an antenna system to precisely lock on an orbiting satellite, three coordinate factors may be taken into consideration: (1) celestial coordinates of the satellite, including a right ascension (R.A.) angle and a declination (Decl.) angle; (2) geographic coordinates of the antenna system (i.e. the SNG vehicle), including a longitude and a latitude; and (3) the direction state of the vehicle mounted with the antenna system, including an azimuth angle and an elevation angle of the vehicle.

In the prior art, an initialization step may be often used to calibrate the antenna system as well as the vehicle in position and direction, for example, azimuth angles and elevation angles. In the initialization step, a base reference position is specifically defined for interrelating the satellite coordinates and the antenna direction. However, when a vehicle that carries the antenna system is moving, which may thus act like a noise (perturbation) source to the antenna system, bias in the angling and positioning of the antenna system with respect to the vehicle may occur from time to time. Consequently, even though satellite data can be loaded and satellite coordinates can be captured, it may be difficult for the antenna system of the mobile broadcasting type to precisely lock on the target satellite.

Furthermore, when a target satellite is determined and the related satellite parameters are downloaded from the database of the antenna system, another issue may occur: only the satellite programs and program channels transmitted by the single target satellite are available. Since different satellite programs may be broadcast by different satellites, it may be inevitable to switch among satellites. During a channel change, new satellite coordinates as well as the broadcasting channel need to be manually or semi-automatically (initiated every time by a user) reloaded for re-directing the antenna system to the new satellite so that a desired satellite program and the channels provided by the new satellite are available to the user. Apparently, such a channel change between different satellites may be laborious and not user friendly.

It may therefore be desirable to have an improved satellite lock-on technique that allows a mobile antenna system to precisely, promptly and automatically lock on a target satellite.

### SUMMARY OF THE INVENTION

Accordingly, it is an object of the present invention to provide a method and an antenna system for satellite lock-on by channel selection to the vehicle carrying the antenna system, in which favorite channels and satellite coordinates of the corresponding satellites are related in advance, and by which a channel change involving a new lock-on upon one of those preset satellites can be easily achieved for the customer by simply determining a favorite channel to implicitly and automatically generate a channel selection signal for initiating the new lock-on.

It is another object of the present invention to provide a method and an antenna system for satellite lock-on by channel selection, in which a specific space scanning for obtaining real-time data of the antenna system and the vehicle is utilized to further realize the satellite coordinates of all the feasible satellites in the space, and by which an effective direction of the antenna system to a target satellite can be ensured.

In the present invention, a carrier vehicle plays the platform for mounting the antenna system and for executing thereon the method for satellite lock-on by channel selection. In the method, a channel selection signal is utilized to initiate a lock-on upon a target satellite among various feasible satellites in the space. The method is characterized in: that a plurality of satellite coordinates for respective satellites are pre-stored in a relevant memory unit, for example a specific memory unit of the antenna system; that a correlation between the individual channels and the corresponding satellites is established; that the correlation is recorded to a satellite channel table; that the channel selection signal is generated as soon as one or more channels are selected; that, in accordance with the channel selection signal and the aforesaid table, the respective satellite coordinate of the target satellite mainly responsible to the selected channels is determined and further a corresponding antenna control signal is generated thereby; and finally that, in accordance with the antenna control signal, a driving signal is generated to drive the antenna system to lock on the target satellite responsible to the selected channels. In the present invention, the antenna system may include at least one antenna, for example a flat antenna and a dish antenna at the same time.

Preferably, in a space scanning of the present method which scans the sky at a region coordinated relevantly in advance for data sampling, an estimated location of a distant satellite is determined by judging if or not a local peak value in signal strength is found in a specific coordinate. The coordinate exhibiting the local peak value in signal strength is defined as a satellite coordinate.

Preferably, in the present invention, the satellite coordinate can corporate with the vehicle coordinates, including the GPS (Global positioning system) coordinate of the vehicle and the direction state of the vehicle, so as to more precisely point the antenna system to the target satellite.

By providing the present invention, real-time satellite coordinates can be obtained by the space scanning to better meet the current states of the antenna system and the vehicle. Upon such an arrangement, all possible mechanical deviations in the antenna tracking system can be properly compensated. Thus, quality in transmitting and/or receiving satellite signals of the antenna system can be substantially guaranteed.

By providing the correlation and the satellite channel table to integrate the channels and the satellites as well as the satellite coordinates, the correct satellite coordinate for the selected channel can be directly located and thus redirecting the antenna system to a new satellite for the selected channel can be promptly and easily. Upon such an arrangement, a channel alteration involving a satellite shift does no longer need a renewal download of satellite coordinates. Therefore, convenience in entertaining the satellite programs can be much joyful.

All these objects are achieved by the method and the antenna system for satellite lock-on by channel selection described below.

### BRIEF DESCRIPTION OF THE DRAWINGS

The present invention will be specified with reference to its preferred embodiment illustrated in the drawings, in which:

FIG. 1 is a schematic view of a vehicle equipped with an antenna system in accordance with an embodiment of the present invention;

FIG. 2 is a functional block diagram of the antenna system in accordance with the present invention;

FIG. 3 shows a typical satellite band table in accordance with the present invention, including headers in bands, satellite numbers, satellite coordinates and vehicle coordinates;

FIG. 4 shows a typical satellite channel tables in accordance with the present invention, including headers in channels, bands and satellite numbers;

FIG. 5 shows a combination of FIG. 3 and FIG. 4 and further adding thereon satellite shift control marks; and

FIGS. 6 and 6A are flow diagrams of a method for satellite lock-on by channel selection in accordance with an embodiment of the present invention.

### DESCRIPTION OF THE PREFERRED EMBODIMENT

The invention disclosed herein is directed to a method and an antenna system for satellite lock-on by channel selection. In the following description, numerous details are set forth in order to provide a thorough understanding of the present invention. It will be appreciated by one skilled in the art that variations of these specific details are possible while still achieving the results of the present invention. Under such a circumstance, there is a preferred embodiment described herein and a flowchart applied for the embodiment is provided to illustrate the present invention in details.

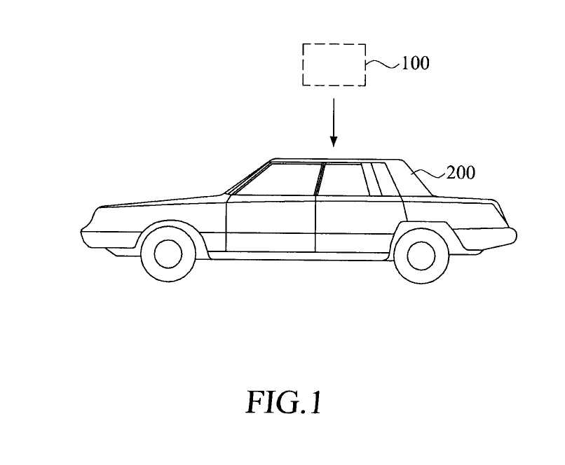

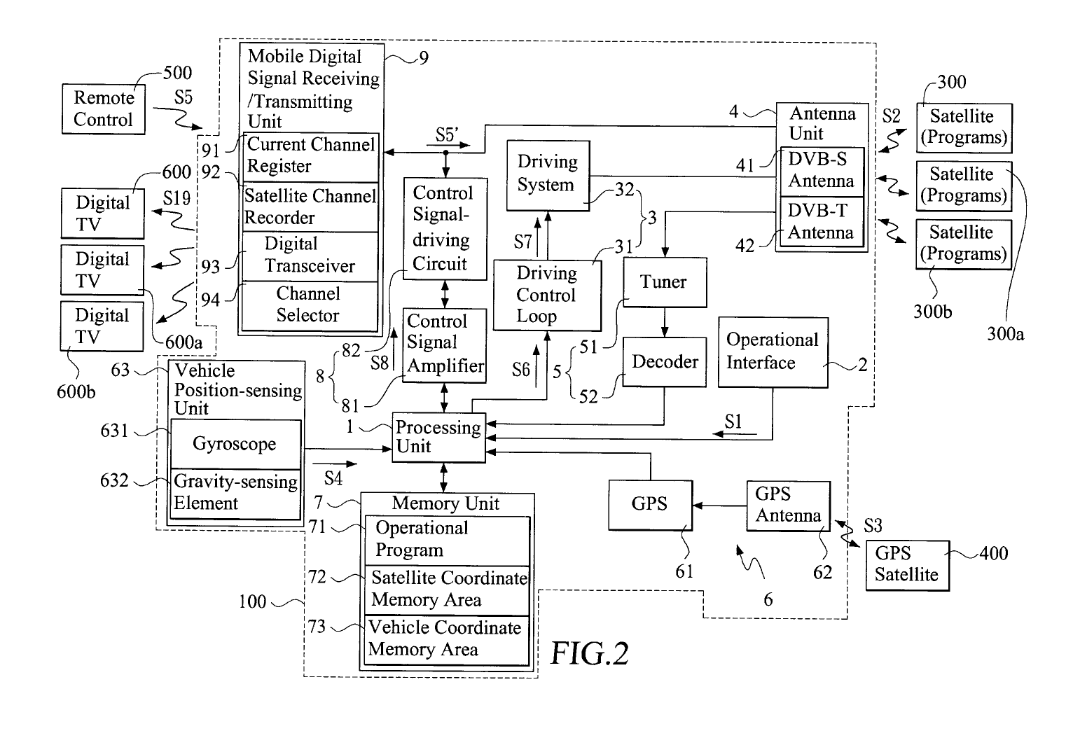

Referring now to FIG. 1 and FIG. 2, in a preferred embodiment of the present invention, an antenna system 100 on a carrier vehicle 200 may include at least a processing unit 1, an operational interface 2, a driving system 3, an antenna unit 4 for receiving/transmitting signals, a satellite signal-processing loop 5, a positioning unit 6, a memory unit 7, a control signal-processing loop 8 and a mobile digital signal receiver 9. Furthermore, for simplicity of disclosure, three prospective (TV) satellites 300, 300a, and 300b are illustrated.

The operational interface 2 coupled with the processing unit 1 may be an operation panel. The driving system 3 includes a driving control loop 31 and a driving system 32. The driving control loop 31 is coupled electrically with the processing unit 1, and the driving system 32 is coupled electrically with the driving control loop 531 and the antenna unit 54. The antenna unit 4 further includes a DVB-S (Digital video broadcasting-satellite) antenna 41 and a DVB-T (Digital video broadcasting-terrestrial) antenna 42, in which the DVB-S antenna 41 may be a dish or flat antenna. In the present invention, the driving system 32 may be a step motor for driving both the DVB-S antenna 41 and the DVB-T antenna 42.

The satellite signal-processing loop 5 includes a tuner 51 and a decoder 52. The tuner 51 is coupled with the antenna unit 4, and the decoder 52 is coupled between the tuner 51 and the processing unit 1. The positioning unit 6 includes a GPS system 61, a GPS antenna 62 and a vehicle position-sensing unit 63. The GPS system 61 is coupled between the GPS antenna 62 and the processing unit 1. The vehicle position-sensing unit 63 is coupled to the processing unit 1 and further includes a gyroscope 631 and a gravity-sensing element 632.

The memory unit 7 coupled with the processing unit 1 further includes an operational program 71, a satellite coordinate memory area 72 and a vehicle coordinate memory area 73. The control signal-processing loop 8 includes a control signal amplifier 81 and a control signal-driving circuit 82. The control signal amplifier 81 is coupled with the processing unit 1. The control signal-driving circuit 82 is coupled between the control signal amplifier 81 and the antenna unit 4. The mobile digital signal receiving/transmitting unit 9, coupled between the antenna unit 4 and the control signal-driving circuit 82, further has a current channel register 91, a satellite channel recorder 92, a digital transceiver 93 and a channel selector 94.

In this embodiment, the operational interface 2 is utilized to set up a scanning pattern (for example, a horizontal scanning or a vertical scanning) and related scanning parameters (such as the range of scanning angles, an angular increment in scanning and a scanning frequency). The operational interface 2 may be triggered to generate a scan-driving signal S1 for the processing unit 1. Based on the scan-driving signal S1, the processing unit 1 may activate the driving system 32 through the driving-control loop 31 so as to drive the DVB-S antenna 41 for a space scanning in accordance with a preset scanning pattern and scanning parameters. During the space scanning, relevant scan data may be obtained at each of the scan coordinates by receiving all satellite signals S2 from all satellites available to the antenna system 100. Then, by analyzing the scan data based on the scan coordinates and sorting all potential local peak values in signal strength, the satellite coordinate (derived from the scan coordinate) of each satellite in the scanned space may be realized. The satellite coordinate is stored in the satellite coordinate memory area 72 of the memory unit 7.

With the space scanning in process, the vehicle 200 can be still in motion. That is, the vehicle coordinate may change from time to time during the space scanning. To ensure the accuracy in locating the satellite, the real-time vehicle coordinate of the moving vehicle 200 is calculated.

In the space scanning, the GPS system 61, through the GPS antenna 62, receives a dynamic position signal S3 from a GPS satellite 400. The signal S3 is then sent to the processing unit 1 for generating a satellite position coordinate to coordinate the vehicle 200. In the mean time, the vehicle position-sensing unit 63 determines a vehicle position for the vehicle 200, and a dynamic position signal S4 according to the vehicle position is formed and then sent to the processing unit 1. The aforesaid vehicle position includes a vehicle azimuth angle and a vehicle elevation angle determined by the gyroscope 631 and the gravity-sensing element 632 of the vehicle position-sensing unit 63, respectively. Both of the satellite position coordinate and the vehicle position are then recorded in the vehicle coordinate memory area 73 of the memory unit 7.

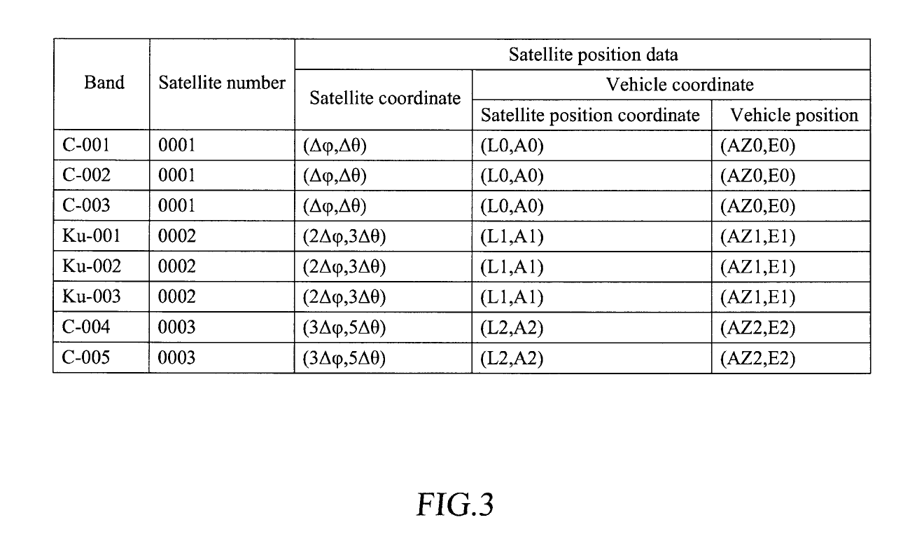

Referring now to FIG. 3, a typical satellite band table in accordance with the present invention is shown to have headers in bands, satellite numbers, satellite coordinates and vehicle coordinates. Also referring to FIG. 2, after the aforesaid space scanning, satellite coordinate realization and documentation into memory unit are finished, a further analysis upon the satellite signal S2, sent from the satellite 300, 300a and/or 300b and received by the DVB-S antenna 41, is processed so as to obtain possible frequency bands for satellite programs carried by the satellite signal S2. Then, a look-up table like FIG. 3 may then be formed by correlating the bands, the satellite coordinates, the vehicle coordinates and the corresponding satellite numbers with respect to individual satellite coordinates. This correlation table may be stored in the memory unit 7. It is noted in FIG. 3 that the vehicle coordinate includes the satellite position coordinate and the vehicle position. Furthermore, the satellite numbers 0001, 0002 and 0003 correspond to the satellites 300, 300a and 300b, respectively.

Generally, frequency bands transmitted by the satellite 300, 300a and/or 300b may be classified into a C band and a Ku band. The C band covering the frequency range from 3.4 gigahertz (GHz) to 4.2 GHz is the band applicable to global broadcasting, semi-sphere broadcasting and oversea broadcasting. The Ku band, a 2 GHz band above from 10.75 GHz to 12.75 GHz, is applicable to regional broadcasting, point-to-point or peer-to-peer broadcasting, direct satellite broadcasting, relay broadcasting for satellite news gathering (SNG) and so on.

When the satellite channel table is made, the processing unit 1 transmits the bands for the satellite programs carried by the satellite signal S2 to the mobile digital signal receiving/transmitting unit 9 through the control signal-processing loop 8 such that the correlation between the channels, bands and the satellite numbers may be identified.

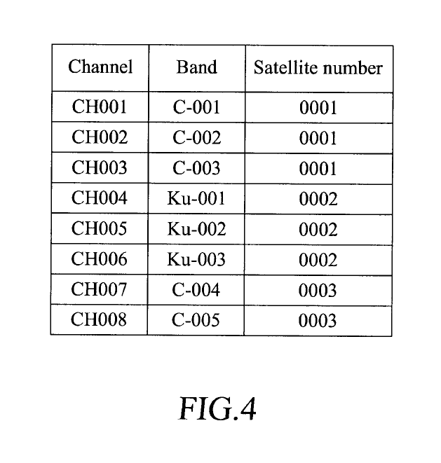

Referring now to FIG. 4, a typical satellite channel table in accordance with the present invention is shown to include only headers in channels, bands and satellite numbers. Referring also to FIG. 2, after the channels are set up, the corresponding bands and satellite numbers may be integrated to form the table of FIG. 4 so as to generate a look-up table for checking up the channels. The table is stored in the satellite channel register 92 of the mobile digital signal receiving/transmitting unit 9.

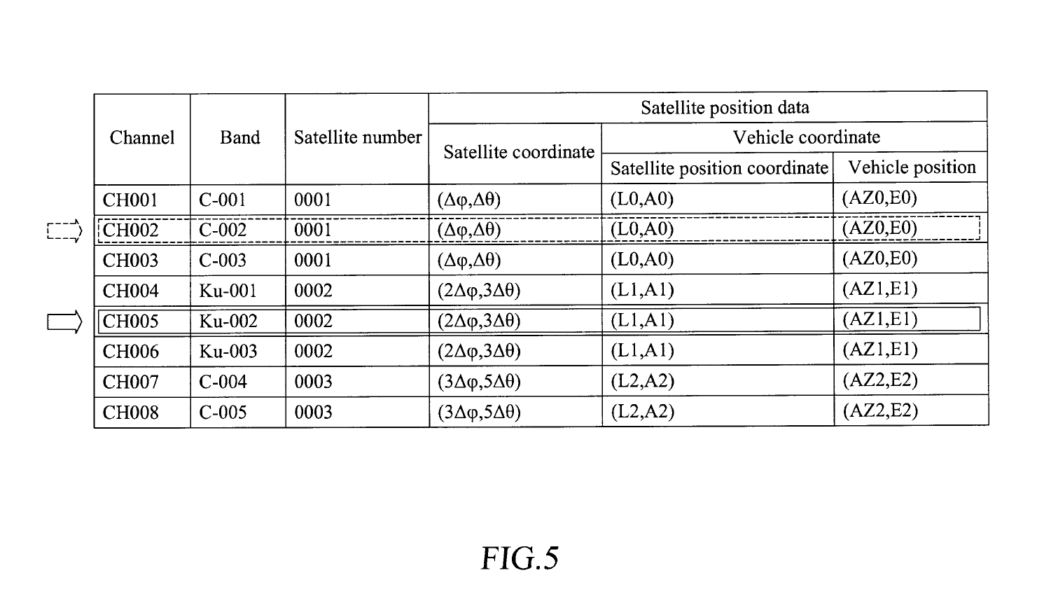

Referring now to FIG. 5, the tables shown in FIG. 3 and FIG. 4 are integrated by further adding satellite shift control marks, resulting in a satellite directing control table with headers in channels, bands, satellite numbers, satellite coordinates and vehicle coordinates. Also referring to FIG. 2, such integration of the tables of FIG. 3 and FIG. 4 into that of FIG. 5 is performed by the processing unit 1. The produced satellite directing control table of FIG. 5 is then stored in the memory unit 7.

Alternatively, a second formulation other than FIG. 5 to integrate the satellite band table of FIG. 3 and the satellite channel table of FIG. 4 may be possible and easily be achieved by skilled persons in the art after reading the aforesaid description in formulating FIG. 5. The second formulation may also be stored in the satellite channel register 92. In addition, other than the form shown in FIG. 4, the satellite channel table of the present invention may be formulated in a format similar to that of FIG. 5 and then stored in the satellite channel register 92. In other embodiments, the satellite channel table may be any other format so long as the format can elucidate correlation among channels, satellites (either by number or by code) and bands.

Referring to FIG. 5, a dashed arrow and a dashed block indicate a pre-change (current) state of the corresponding antenna system 100. In this state, the channel is at CH002, the band is at C-002, the satellite number is 0001 (i.e., satellite 300), the satellite coordinate is (Δφ,Δθ), the satellite position coordinate is (L0, A0), and the vehicle position is (AZ0, E0). The present channel CH002 is accessible from the current channel register 91. While the satellite program is entertained without altering the channel, the aforesaid data related to the channel CH002 may be downloaded to the processing unit 1 from the current channel register 91.

In the present invention, three methods may be used to preset the default channel (which is shown while the antenna system 100 is turned on). A first one is to initialize the antenna system 100 for determining the default channel. A second one is to use a remote control 500 or the mobile digital signal receiving/transmitting unit 9 to determine the default channel. And, a third one is to assign the last channel in previous turn-off to be the default channel in the current turn-on. In implementation, the third method may often be used.

In receiving programs of CH002, after the aforesaid channel and satellite parameters are downloaded to the processing unit 1, a GPS dynamic positioning signal S3 and a vehicle-position dynamic positioning signal S4 are used to obtain the real-time vehicle coordinate. At the same time, the operational program 71 may compute a required amount of adjustment for the antenna system 100 based on the satellite coordinate (Δφ, Δθ), the satellite position coordinate (L0, A0), the vehicle position (AZ0, E0) and the real-time vehicle coordinate so as to generate and send an antenna control signal S6 to the driving control loop 31. The driving control loop 31 then sends a driving signal S7 based on the signal S6 to the driving system 32 so as to drive the DVB-S antenna 41 of the antenna unit 4 to direct at the satellite 300. With such an arrangement, the DVB-S antenna 41 may receive continually satellite programs of the C-002 band from the satellite 300.

In changing the channel, the remote control 500 sends a remote control signal S5 to the mobile digital signal receiving/transmitting unit 9. Alternatively, the channel selector 94 of the mobile digital signal receiving/transmitting unit 9 may be directly used to change the channel. After the new channel is decided, the mobile digital signal receiving/transmitting unit 9 may send a channel switch signal S5′ to the processing unit 1 via the control signal-processing loop 8. In FIG. 5, the new channel is the channel CH0005, within the band Ku-002, having the satellite number 0002 (for satellite 300a), the satellite coordinate (2Δφ, 3Δθ), the satellite position coordinate (L1, A1) and the vehicle position (AZ1, E1). According to the aforesaid method for defining the default channel, the new channel CH005 may be stored in the current channel register 91 as the new default channel.

In the antenna movement, the GPS dynamic positioning signal S3 and the vehicle-position dynamic positioning signal S4 are used to obtain the real-time vehicle coordinate. At the same time, the operational program 71 may compute a required amount of adjustment for the antenna system 100 based on the satellite coordinate (2Δφ, 3Δθ), the satellite position coordinate (L1, A1), the vehicle position (AZ1, E1) and the real-time vehicle coordinate so as to generate and send an antenna control signal S6 to the driving control loop 31. The driving control loop 31 then sends a driving signal S7 based on the signal S6 to the driving system 32 so as to drive the DVB-S antenna 41 of the antenna unit 4 to direct at the satellite 300a. Thereupon, the DVB-S antenna 41 may receive continually satellite programs of the Ku-002 band from the satellite 300a.

In order to control the mobile digital signal receiving/transmitting unit 9, the operational interface 2 may be triggered so that the processing unit 1 transmits a control signal S8 to the control signal amplifier 81. The control signal amplifier 81 then amplifies the control signal S8 and transmits the amplified signal to the control signal-driving circuit 82, by which the mobile digital signal receiving/transmitting unit 9 may be controlled.

Prior to receiving the satellite signal S2, the processing unit 1 downloads at least one digital video data from the memory unit 7. The digital video signal is transformed into a DVB-T video signal S9 by the mobile digital signal receiving/transmitting unit 9 and then broadcast to the digital TVs 500, 500a and 500b via the digital transceiver 93. Meanwhile, the DVB-T antenna 42 is used to receive foreign DVB-T video signals and restore the data realized from the DVB-T signals in the memory unit 7 via the processing unit 51. Alternatively, the mobile digital signal receiving/transmitting unit 59 may transform the foreign DVB-T video signals into respective DVB-T video signal S9 for further broadcasting.

When the satellite signal S2 is received, the processing unit 1 downloads at least one digital video data from the memory unit 7. The digital video signal is transformed into a DVB-S satellite signal S2 or a DVB-T video signal S9 by the mobile digital signal receiving/transmitting unit 9. Then, the DVB-S satellite S2 is sent to the satellite 300, 300a or 300b by the DVB-S antenna 41, while the DVB-T video signal S9 is sent by the digital transceiver 93 of the mobile digital signal receiving/transmitting unit 9 to the digital TVs 600, 600a or 600b.

In the mean time, the satellite (any of satellite 300, 300a and 300b responsible to the new channel) determined by the selected channel based on the channel selection signal S5′ sends the satellite signal S2 to the tuner 51 via the DVB-S antenna 41 for modulation. The tuned signal S2 is then decoded by the decoder 52 and sent to the processing unit 1. The processing unit 1 transforms data of the decoded satellite signal S2 into respective digital satellite (program) data, which may then be stored in the memory unit 7.

In addition, the selected satellite (any of satellite 300, 300a and 300b responsible to the new channel) determined by the selected channel based on the channel selection signal S5′ may send the satellite signal S2 via the DVB-S antenna 41 to the mobile digital signal receiving/transmitting unit 9 so that the signal S2 may be transformed into the respective DVB-T video signal S9. The DVB-T video signal S9 is broadcast to and received by the digital TVs 600, 600a and 600b. Skilled persons in the art will understand that the control signal S8 for controlling the mobile digital signal receiving/transmitting unit 9 may be able to help control the transformation between and transmission of the signal S2 and the signal S9.

In one embodiment, the mobile digital signal receiving/transmitting unit 9 may be equipped with an on-screen display (OSD) interface. The OSD interface may replace the aforesaid operational interface. Specifically, the OSD interface may be operated to control various operations and controls of the antenna system 100.

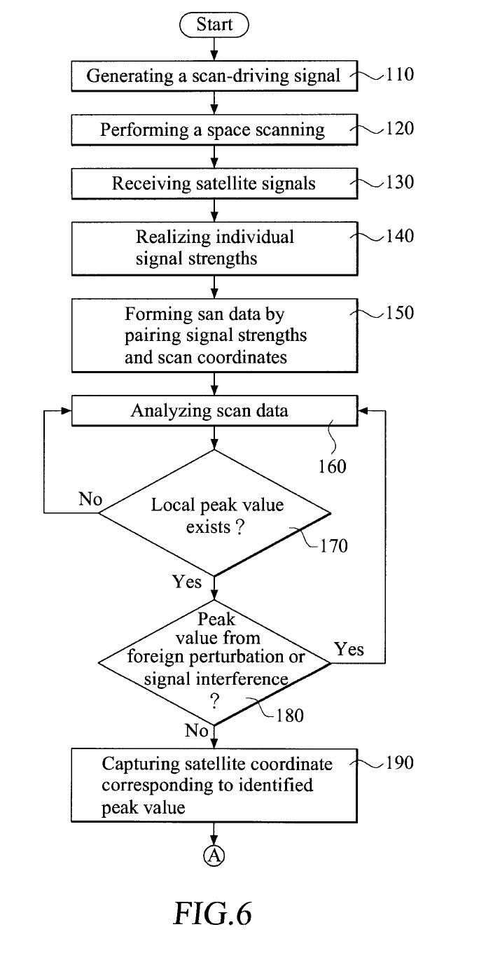

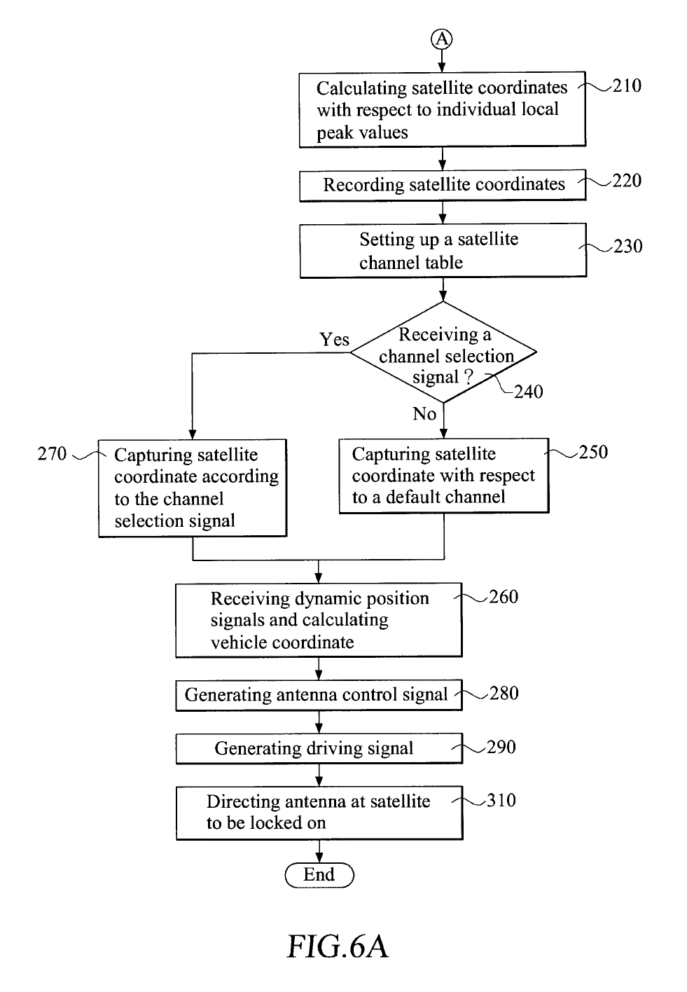

Referring now to FIG. 6 and FIG. 6A that illustrate a method for satellite lock-on by channel selection in accordance with an embodiment of the present invention. Also referring to FIG. 2, to start the method, the operational interface 2 is triggered firstly to send a scan-driving signal S1 to the processing unit 1 (Step 110). Thereby, the DVB-S antenna 41 proceeds to perform a space scanning (Step 120).

Thereafter, the DVB-S antenna 41 receives satellite signals S2 from the satellites 300, 300a and/or 300b (Step 130). Based on each of the scan coordinates, the received satellite signal S2 is realized into individual signal strengths (Step 140). Scan data are thus formed by pairing the signal strengths with the respective scan coordinates (Step 150).

An analysis is performed upon the scan data (Step 160) so as to determine if a local peak value in signal strength exists (Step 170). If not, Step 160 is repeated. If confirmative, it is determined whether the peak value is a result of foreign perturbation or signal interference (Step 180). If confirmative in Step 180, Step 160 is repeated. If not, record/capture the scan coordinate with respect to the instant peak value (Step 190).

After all of the candidate scan coordinates are screened, the respective satellite coordinate for every individual satellite within the scanning coverage of the space scanning is thus determined from the pool of plural scan coordinates. In one embodiment according to the present invention, the derivation of a specific satellite coordinate from the scan coordinates may be made by a simple relevant replacement by replacing the respective satellite coordinate with the most likely scan coordinate. In another embodiment, an interpolating coordinate to serve as the satellite coordinate may be obtained by weighting the neighboring scan coordinates based on a proper criterion. In still another embodiment, a derivative coordinate may be obtained from an analysis based on a mathematical regression method. Skilled persons in the art will understand that the determination of the satellite coordinates is a matter of mathematics and can be easily resolved as long as the signal strength at every scan coordinate is provided. Therefore, details of such determination methods and mathematics are omitted herein.

Then, in step 210, the GPS dynamic position signal S3 and the vehicle-position dynamic position signal S4 are used to obtain the vehicle coordinate. The vehicle coordinate may include the aforesaid satellite position coordinate and the vehicle position. Furthermore, based on the scan coordinates showing the local peak values in signal strength, the respective satellite coordinates that most likely to exist may be realized. Next, in Step 220, the satellite coordinates and the vehicle coordinate are stored in the satellite coordinate memory area 72 and the vehicle coordinate memory area 73 of the memory unit 7, respectively.

Subsequently, a plurality of channels may be set up. Each of the channels may be correlated to one of the corresponding satellite numbers and bands. The satellite channel table to record the aforesaid correlation-ship is stored in the satellite channel register (Step 230).

The processing unit 1 may then determine whether a channel selection signal S5′ is received (Step 240). If the remote control 500 or the channel selector 94 is not introduced to generate the channel selection signal S5′, the processing unit 1 may not receive the channel selection signal S5′. At this time, the processing unit 1 may retrieve the default channel temporarily stored in the current channel register 91 and use the default channel as the current channel. The corresponding satellite coordinate with respect to the current channel is then captured in order to perform the following satellite shift (Step 250). In this embodiment, the default channel is the channel CH002 corresponding to the satellite 300. After the satellite coordinate is retrieved, the processing unit 1 may compute the real-time vehicle coordinate based on the GPS dynamic position signal S3 and the vehicle-position dynamic position signal S4 (Step 260).

On the other hand, if the remote control 500 or the channel selector 94 is introduced to generate the channel selection signal S5′, the processing unit 1 may receive the channel selection signal S5′ and retrieve the satellite coordinate corresponding to the selected satellite based on the channel selection signal S5′ (Step 270). The method goes to Step 260 after Step 270 is performed. In this embodiment, the selected channel is channel CH005 and the selected satellite is the satellite 300a, also referring to FIG. 5.

After Step 260 is performed, the processing unit 1 may generate and send an antenna control signal S6 to the driving control loop 31 based on the satellite coordinate, the vehicle coordinate and the current real-time vehicle coordinate (Step 280). The driving control loop 31 then generates and sends a driving signal S7 to the driving system 32 based on the antenna control signal S6 (Step 290). Subsequently, the driving system 32 may drive the DVB-s antenna to direct at the satellite to be locked upon based on the driving signal S7 (Step 310).

In the aforesaid embodiments, terminologies DVB-T, DVB-S and DVB-S/T are adopted. However, it is well known that, in other applications, different terminologies might be used though the contents and elements involved are the same. For example, the DMB-T/H specs in China, and the ATSC (Advanced television systems committee) specs in USA are similar to the DVB-T, DVB-S and DVB-S/T systems.

To those who are ordinarily skilled in the art, the aforesaid description upon the present invention is easily understood. The satellite lock-on technique provided herein is to obtain scan data and thus the satellite coordinates that do better meet the current states of the antenna system and the carrier vehicle. Thereby, possible position bias caused by aging and foreign or mechanical perturbations to the antenna system can be reduced to a minimum, and also the directing of the antenna system as well as its receiving and transmitting can be further ensured.

Equally importantly, by providing correlation among the satellite numbers, the channels and the bands, switching in satellite programs can be much conveniently. Obviously, by providing the present invention, channel switch between programs subscribed from different satellites can be done without reloading the satellite data and/or re-setting the channels. Thus, entertainment quality in satellite programs can be substantially enhanced.

While the present invention has been particularly shown and described with reference to a preferred embodiment, it will be understood by those skilled in the art that various changes in form and detail may be without departing from the spirit and scope of the present invention.

I claim:

1. An antenna system mounted on a vehicle for automatically locking on one of plural satellites in the space according to a channel selection signal directing to a channel to be selected, the antenna system comprising:
at least an antenna;
a driving system coupled with the antenna;
a driving control loop coupled with the driving system for driving the driving system;
a processing unit coupled with the driving control loop;
a memory unit coupled with the processing unit for storing satellite coordinates of the individual satellites; and
a mobile digital signal receiving/transmitting unit coupled with the processing unit and the antenna, having a plurality of channels (including the channel to be selected) and a satellite channel register for recording a satellite channel table that relates the channels to the corresponding satellites,
wherein upon being triggered the mobile digital signal receiving/transmitting unit transmits the channel selection signal to the processing unit, the satellite coordinate of the satellite for providing the channel to be selected is retrieved from the satellite channel table, an antenna control signal is sent to the driving control loop according to the retrieved satellite coordinate, a driving signal generated by the driving control loop is sent to the driving system, and thereby the antenna is driven by the driving system to direct at the satellite corresponding to the channel to be selected.

2. The antenna system according to claim 1, further including an operational interface coupled with said processing unit for sending said scan-driving signal to said driving control loop while the operational interface is triggered.

3. The antenna system according to claim 1, wherein said at least an antenna unit includes a digital video broadcasting-satellite (DVB-S) antenna for receiving at least a satellite signal and thereafter establishing a channel corresponding to the satellite signal.

4. The antenna system according to claim 1, wherein said at least an antenna is selected from a group of a dish antenna and a flat antenna.

5. The antenna system according to claim 1, wherein said at least an antenna has at least a DVB-s antenna and a DVB-T (digital video broadcasting-terrestrial) antenna, and said driving system is coupled with the DVB-S antenna.

6. The antenna system according to claim 1, further having a control signal-processing loop, wherein the control signal-processing loop further includes a control signal amplifier coupled with said processing unit for magnifying a control signal sent from said processing unit.

7. The antenna system according to claim 6, wherein said control signal-processing loop further includes a control signal-driving circuit coupled with said mobile digital signal receiving/transmitting unit, said control signal amplifier and said antenna, wherein the control signal-driving circuit controls said mobile digital signal receiving/transmitting unit according to said control signal.

8. The antenna system according to claim 1, further including a satellite signal-processing loop having a tuner coupled with said antenna for tuning at least a satellite signal received by said antenna.

9. The antenna system according to claim 8, wherein said satellite signal-processing loop further has a decoder coupled with said tuner.

10. The antenna system according to claim 1, further including:
a global positioning system (GPS) coupled with said processing unit; and
a GPS antenna coupled with the GPS for obtaining a satellite position coordinate of said vehicle and further transmitting said antenna control signal according to said satellite position coordinate and said satellite coordinate of said target satellite.

11. The antenna system according to claim 1, further including a vehicle position-sensing unit coupled with said processing unit for obtaining a vehicle position of said vehicle, said antenna control signal being sent according to the vehicle position and said satellite coordinate of said target antenna.

12. The antenna system according to claim 11, wherein said vehicle position further includes an azimuth angle of said vehicle and an elevation angle of said vehicle and said vehicle position-sensing unit further includes:
a gyroscope for determining the azimuth angle; and
a gravity-sensing element for determining the elevation angle.

13. The antenna system according to claim 1, wherein said memory unit further includes:
a satellite coordinate memory area for storing said satellite coordinates of said satellites; and
a vehicle coordinate memory area for storing a vehicle coordinate and a vehicle position of said vehicle.

14. The antenna system according to claim 1, wherein said driving system is a step motor.

15. A method for satellite lock-on by channel selection, utilizing a channel selection signal to initiate at least one antenna to lock on at least one of a plurality of satellites in the space, the method comprising:
(a) recording satellite coordinates individually with respect to the satellites;
(b) setting up a plurality of channels and relating the corresponding satellites with the individual channels into a satellite channel table;
(c) selecting at least one of the channels and generating a corresponding channel selection signal;
(d) receiving the channel selection signal and further generating a control signal according to the satellite coordinate of the satellite that is related to the channel indicated by the channel selection signal; and
(e) according to the control signal, generating a driving signal to drive the antenna to direct at the satellite related to the selected channel.

16. The method according to claim 15, wherein said step (a) is performed posterior to a step (a0) of receiving a scan-driving signal to drive said antenna to start a space scanning so as to detect said satellite coordinates of said individual satellites.

17. The method according to claim 16, wherein said step (a) further includes a step (a1) of receiving a dynamic position signal for realizing at least a vehicle coordinate of said antenna, the vehicle coordinate being further used to compensate calculation of said satellite coordinates.

18. The method according to claim 17, wherein said dynamic position signal is a GPS dynamic position signal and said vehicle coordinate includes a satellite position coordinate of said vehicle.

19. The method according to claim 17, wherein said dynamic position signal is a vehicle-position dynamic position signal and said vehicle coordinate includes a vehicle position of said vehicle.

20. The method according to claim 17, wherein said antenna control signal is sent in accordance with said satellite coordinates and said vehicle coordinate.

21. The method according to claim 15, wherein said step (c) is performed posterior to a step (c0) of determining whether or not said channel selection signal is received.

22. The method according to claim 21, wherein said step (c) further includes a step (c1) of capturing said satellite coordinate of said corresponding satellite for a default channel if an answer for said step (c0) is negative.

23. The method according to claim 15, wherein said antenna is a digital video broadcasting-satellite (DVB-S) antenna.

24. The method according to claim 23, wherein said antenna is selected from a group of a dish antenna and a flat antenna.
